(19) United States
(12) Patent Application Publication
(10) Pub. No.: US 2019/0385067 A1
(43) Pub. Date: Dec. 19, 2019

(54) Automatic reliability analysis method for warm standby system based on multi-state decision diagram

(71) Applicant: ZHEJIANG UNIVERSITY, Hangzhou, Zhejiang (CN)

(72) Inventors: Yi Ding, Hangzhou, Zhejiang (CN); Heping Jia, Hangzhou, Zhejiang (CN); Hanlin Liu, Hangzhou, Zhejiang (CN); Rui Peng, Hangzhou, Zhejiang (CN); Yonghua Song, Hangzhou, Zhejiang (CN); Chuangxin Guo, Hangzhou, Zhejiang (CN)

(21) Appl. No.: 16/095,355

(22) PCT Filed: Jul. 4, 2017
(86) PCT No.: PCT/CN2017/091661

§ 371 Date: Oct. 20, 2018

(30) Foreign Application Priority Data
Jun. 16, 2017 (CN) 201710456036.4

(51) Int. Cl. G06N 5/02; G06N 7/00; G06F 17/13

(52) U.S. Cl. CPC G06N 5/022; G06F 17/13; G06N 7/005

(57) ABSTRACT

An automatic reliability analysis method for a warm standby system based on a multi-state decision diagram is provided. A multi-state model is constructed for the system with multi-state components; then, according to possible state transitions of every component in the system, the multi-state decision diagram is constructed. Through construction, simplification and decomposition of the multi-state decision diagram, an occurrence probability of each path in the multi-state decision diagram is obtained with integral operation. The occurrence probability of each path in the multi-state decision diagram is further calculated with considering a failure probability of activation of the warm standby components, so as to obtain system reliability. The present invention takes the warm standby system with the multi-state components as an object, and is able to programmatically process the multi-state components whose state transitions follow arbitrary distributions with high accuracy and fast computing speed. Moreover, the present invention is of great significance to reliability analysis theories and engineering applications of the multi-state system whose state transitions follow the arbitrary distributions.

### CROSS REFERENCE OF RELATED APPLICATION

This is a U.S. National Stage under 35 U.S.C 371 of the International Application PCT/CN2017/091.661, tiled Jul. 04, 2017, which claims priority under 35 U.S.C. 119(a-d) to CN 201710456036.4, filed Jun. 16, 2017.

### BACKGROUND OF THE PRESENT INVENTION

### Field of Invention

The present invention belongs to a field of reliability analysis of complex engineering systems, especially to an automatic reliability analysis method for a warm standby system based on a multi-state decision diagram. The method analyzes the reliability of the warm standby system with multi-state components through utilizing the multi-state decision diagram.

### Description of Related Arts

To enhance the reliability of engineering systems, redundancy technologies such as hot standby, cold standby, and warm standby are typically utilized to supplement standby components to the system. Once operating components suffer from failures, the standby components can take the work and maintain the high system reliability. It should be noted that there might be several intermediate states between perfect functioning and complete failure, which leads to the component presenting the multi-state characteristic. The existing methods have certain limitations in the reliability analysis of warm standby systems with multi-state components. For example, the Markov process model requires that the state transitions of components obey exponential distributions; the binary decision diagram method can be only applied to systems with binary-state components; the Monte Carlo simulation method can only get approximate results, and generally requires longer computing time compared with analytic methods. Therefore, for practical engineering systems, reliability analysis of standby systems with multi-state components whose state transitions are subject to arbitrary distribution is critical, which is of great significance for perfecting the multi-state reliability analysis theory.

### SUMMARY OF THE PRESENT INVENTION

A purpose of the present invention is to provide an automatic calculation method for reliability analysis of a warm standby system with multi-state components based on a multi-state decision diagram.

According to the method, a multi-state model is firstly constructed for the system with the multi-state components; then, according to component capacities of different states and system requirements, the multi-state decision diagram for the system after state transitions is constructed. Through construction, simplification and decomposition of the multi-state decision diagram, occurrence probabilities of edges of each path in sub-diagrams of the multi-state decision diagram are obtained after integral operation and then multiplied by an occurrence probability of a root node, so as to obtain an occurrence probability of each path considering start failures of the components. Finally, the occurrence probabilities of all the paths in the multi-state decision diagram are added up, so that the system reliability is obtained. Automatic calculation of the method can be realized through programming instead of manual calculation.

The present invention has guiding significance for the theoretical reliability analysis of engineering systems including multi-state standby systems. Moreover, the present invention provides scientific basis for reliability analysis and evaluation of standby systems consisting of multi-state components subjected to arbitrarily state transition distribution.

The technical solutions adopted by the present invention are described as follows.

An automatic reliability analysis method for a warm standby system based on a multi-state decision diagram comprises steps of:

(1), constructing a multi-state model for the system with multi-state components;

(2), according to possible state transitions of every component in the system, constructing the multi-state decision diagram;

(3), calculating an occurrence probability Pₑ of an e^{th} path in the multi-state decision diagram;

(4)_{;} with considering start failure probabilities of the components, modifying the occurrence probability of the e^{th} path in the multi-state decision diagram into P′ₑ; and

(5), calculating a system reliability P_{system}.

The multi-state model in the step (1) is constructed as follows.

The system consists of N multi-state components Aᵢ (i=1, . . . ,N) which are sequentially numbered, wherein i represents a component sequence number; N represents a total number of the components; an i^{th} component Aᵢ has Bᵢ states which are sequentially numbered and two working modes, respectively an operating mode and a warm standby mode.

Capacities corresponding to the states are gradually decreased in a state numbering sequence. A capacity of the i^{th} component Aᵢ in a j^{th} state is C_{i,j} (j=1, . . . ,Bᵢ), wherein j represents a state sequence number. A capacity demand of the system is D.

At an initial time, all components are in a first state. Moreover, the working mode of each component is set as follows. Former k components Aᵢ are in the operating mode, and remaining (N−k) components Aᵢ are in the warm standby mode. A total amount of capacities of the former k components is larger than or equal to the system capacity demand D; and a total amount of capacities of former (k−1) components is smaller than the system capacity demand D.

Because the method analyzes the reliability of the system during operation, considering that the components are not maintainable during operation, the multi-state model does not consider maintenance of the components.

All the possible state transitions of every component in the system are considered, and an available capacity of the system after each state transition process is calculated to construct the multi-state decision diagram. If the available capacity of the system cannot satisfy the system capacity demand after the state transition process or no more state transition can happen, construction of the multi-state decision diagram is terminated. It should be noted that, if one component in the operating mode in the system has state transition, one or more components in the warm standby mode may be activated into the operating mode.

The state transition processes of the components in the system are set as follows. One state transition process of one component is set as one state transition process of the system. That is to say, for each state transition process of the system, only one component has state transition. After each state transition process of the system, one layer of components is added in the multi-state decision diagram. Each state transition process is a transition process from a state in a current sequence number to a state in a next sequence number.

During the construction of the multi-state decision diagram, after each state transition process of the component, a total amount of capacities of all components in the operating mode is required to be not smaller than the system capacity demand D.

The capacity of each component in a respective current state is added up to serve as the current available capacity of the system. The number of the components in the operating mode and the number of the components in the warm standby mode in the system are related to the system capacity demand D. The total amount of the capacities of all the components in the operating mode is required to be not smaller than the system capacity demand D. If the total amount of the capacities of all the components in the to operating mode after the state transition process is smaller than the system capacity demand D, the components in the warm standby mode are activated into the operating mode according to the numbering sequence. Moreover, the working mode can only be converted from the warm standby mode to the operating mode.

After each state transition process of the system, data is recorded, including the sequence number of the component having the state transition, the state of the component before the state transition process and a corresponding starting time of the state, the sequence number of the component in the warm standby mode required to be activated by the system after the state transition process and the corresponding state when activating and a starting time of the state thereof.

In the step (2), the initial time of system operation is set to be t₀, and a time when an h^{th} state transition process happens is set to be tₕ, t₀<t₁< . . . <tₕ< . . . . A comprehensive state of all the components at the initial time of the system serves as the root node of the multi-state decision diagram; possible comprehensive states of all the components of the system after the state transition processes serve as nodes of the multi-state decision diagram; a state transition between two nodes serves as one edge; and coherent edges are connected together to from the paths.

In the step (2), the multi-state decision diagram is constructed through steps of:

(2.1), at the initial time t₀ of the system, adopting a system state before the state transition process to serve as the root node of the multi-state decision diagram, wherein the root node represents a best state of the system, and the available capacity SC₀ of the system is:

$${SC}_{0} = {\sum }_{i = 1}^{N} {C}_{i , 1} ;$$

(2.2), at a time tᵢ when the first state transition process of the system happens, having (N+1) possibilities by the system, including respective state transitions of the N components and no state transition, wherein the root node of the multi-state decision diagram is evolved into (N+1) sub-nodes to serve as the first layer under the root node; and constructing each edge from t₀ to t₁, wherein the available capacity SC₁^{g} of the system under each edge is calculated through a formula of:

$${SC}_{1}^{g} = \{ \begin{matrix}{\sum }_{t = 1 , i \neq g}^{N} {C}_{t , 1} + {C}_{g , 2} ( g = 1 , ⋯ , N ) \\ {\sum }_{i = 1}^{N} {C}_{i , 1} ( g = N + 1 ) \end{matrix} ;$$

wherein: g represents a possible sequence number of the first state transition process of the system; g=N+1 represents that no component has the state transition;

(2.3), at a time 1₂ when the second state transition process of the system happens, having (N+1) possibilities by each possibility (namely each sub-node of the root node) after the first state transition process of the system, that is to say each of the evolved (N+1) sub-nodes is further evolved into (N+1) sub-nodes; and constructing each edge from t₁ to t₂, wherein the available capacity SC₂^{h} of the system under each edge is calculated through a formula of:

$${SC}_{2}^{h} = \{ \begin{matrix}{\sum }_{i = 1 , i \neq g , h}^{N} {C}_{i , 1} + {C}_{g , 2} + {C}_{h , 2} ( g , h = 1 , ⋯ , N ; h \neq g ) \\ {\sum }_{i = 1 , i \neq g , h}^{N} {C}_{i , 1} + {C}_{h , 3} ( h = g = 1 , ⋯ , N ) \\ {\sum }_{i = 1 , i \neq g}^{N} {C}_{i , 1} + {C}_{g , 2} ( h = N + 1 ) \end{matrix} ;$$

wherein: h represents a possible sequence number of the second state transition process of the system; h=N+1 represents that no component has the state transition; and

(2.4), at a time t₃ when the third state transition process of the system happens, calculating in a similar way of steps (2.1)-(2.3); if all the components are in the operating mode and meanwhile the total amount of the available capacities of all the components is smaller than the system capacity demand D or no more state transition can happen (namely the states of all the components are in the maximum sequence number), stopping constructing the multi-state decision diagram.

Preferably, when executing the step (2), two sub-trees having the same composition can be merged to simplify the multi-state decision diagram. That is to say, if two nodes have the same state transition information, the edges pointing to the two nodes can be merged, so that calculation after the state transition needs to be performed only once. The same state transition information includes the time when the state transition is process happens, the components having the state transition; the component state before the state transition process, and the corresponding starting time of the state, the state of the component in the warm standby mode required to be activated after the state transition process and the corresponding starting time of the state.

In the step (3), the occurrence probability Pₑ of the e^{th} path in the multi-state decision diagram is obtained through multiplying product of the occurrence probabilities Prₑ^{g} of the edges which the e^{th} path has passed through by the occurrence probability of the root node.

The nodes in the system multi-state decision diagram can be divided into two types. The first type is that the component has the state transition and no standby component is activated; and the second type is that the component has the state transition and the standby component is activated.

As shown in FIG. 1A and FIG. 1B, for the above two types, there are two cases for the state transition process of the component. The first one is that the component does not have the continuous state transitions; and the second one is that the component has the continuous state transitions, wherein the continuous state transitions means that at least two state transitions continuously happen. As shown in FIG. 1A, a time interval exists between tₚ and tₕ₋₁; no continuous state transitions happen between tₚ and tₕ, and the component does not have the continuous state transitions. As shown in FIG. 1B, tₚ and tₕ₋₁ are the same time; there is no time interval exists between tₚ and tₕ; and the is component has the continuous state transitions.

In the step (3), the component A₁ has three types according to whether the initial working mode and the subsequent working mode thereof are changed. The first type is the component Aᵢ^{y} which is in the operating mode at the initial time; the second type is the component Aᵢ^{s} which is always in the warm standby mode from the initial time; and the third type is the component Aᵢ^{o} which is in the warm standby mode at the initial time and then activated into the operating mode.

That is to say, at the initial time of the system, the former k components Aᵢ are in the operating mode, represented as Aᵢ^{y}(i=1, . . . ,k) ; the remaining (N−k) components Aᵢ are in the warm standby mode and are divided into two types according to whether the warm standby mode thereof is activated into the operating mode, respectively represented as Aᵢ^{s}(i=k+1, . . . ,N) and Aᵢ^{o}(i=1, . . . , k). In the above representations, y represents that the working mode is in the operating mode at the initial time; s represents that the working mode is always in the warm standby mode from the initial time; and o represents the working mode is activated from the warm standby mode into the operating mode.

The occurrence probabilities Prₑ^{g} of the different edges are calculated as follows.

For the first case that the state transition process happens but no warm standby component is activated (namely the first kind of nodes) at the time tₕ, the state transition process can be represented as Aᵢ^{y}|Aᵢ^{s}|Aᵢ^{o}→NA, wherein: Aᵢ^{y}→NA represents that the state of the component Aᵢ^{y} which is in the operating mode at the initial time of the system is transited from Bₚ^{y} to Bₚ₊₁^{y}; Aᵢ^{s}→NA represents that the state of the component Aᵢ^{s} which is always in the warm standby mode from the initial time of the system is transited from Bₚ^{s} to Bₚ₊₁^{s} (at this situation, no component in the warm standby mode of the system is required to be activated); Aᵢ^{o}→NA represents that the state of the component Aᵢ⁰ which is in the warm standby mode at the initial time of the system and then activated into the operating mode after the state transition process is transited from Bₚ^{o} to Bₚ₊₁^{o} (it is noted that this situation will not happen at the first state transition process of the system).

The edges can be divided into three types according to the corresponding state transition process, respectively tₕ{Aᵢ^{y}:Bₚ^{y}→Bₚ₊₁^{y}}, tₕ{Aᵢ^{s}:Bₚ^{s}→Bₚ₊₁^{s}}, and tₕ{Aᵢ^{o}:Bₚ^{o}→Bₚ₊₁^{o} }. The edge tₕ{Aᵢ^{y}:Bₚ^{y}→Bₚ₊₁^{y}} is taken as an example, and the occurrence probability Prₑ^{g}(T) of the edge tₕ{Aᵢ^{y}:Bₚ^{y}→Bₚ₊₁^{y}} is calculated through formulas of:

$$\{ \begin{matrix}\frac{{\int }_{{t}_{h - 1}}^{T} {R}_{{B}_{p}^{y}}^{{A}_{i}^{y}} ( {t}_{h - 1} - {t}_{p} ) {dF}_{{B}_{p}^{y}}^{{A}_{i}^{y}} ( {t}_{h} - {t}_{p} ) {R}_{{B}_{p + 1}^{y}}^{{A}_{i}^{y}} ( T - {t}_{h} )}{{R}_{{B}_{p}^{y}}^{{A}_{i}^{y}} ( T - {t}_{h} )} , {t}_{h - 1} > {t}_{p} \\ \frac{{\int }_{{t}_{h - 1}}^{T} {dF}_{{B}_{p}^{y}}^{{A}_{i}^{y}} ( {t}_{h} - {t}_{p} ) {R}_{{B}_{p + 1}^{y}}^{{A}_{i}^{y}} ( T - {t}_{h} )}{{R}_{{B}_{p}^{y}}^{{A}_{i}^{y}} ( T - {t}_{h} )} , {t}_{h - 1} = {t}_{p} \end{matrix} ;$$

wherein: T represents an operation time of the system; tₕ₋₁(0<tᵢ< . . . <tₕ₋₁<tₕ<T) represents a time when the last state transition process of the system happens; tₚ represents a starting time of the component Aᵢ^{y} in the state Bₚ^{y}; F_{B}_{ₚ}_{^{y}}^{A}^{ᵢ}^{^{y}} is a cumulative distribution function for the state transition process of the component Aᵢ^{y} from the state Bₚ^{y} to the state Bₚ₊₁^{y}; (tₕ−tₚ) represents a time difference between the time when the h^{th} state transition process of the system happens and the time when the system is at the same state; R_{B}_{ₚ}_{^{y}}^{A}^{ᵢ}^{^{y}}(T−tₕ), represents a reliability function for the state transition process of the component Aᵢ^{y} from the state Bₚ^{y} to the state Bₚ₊₁^{y}; R_{B}_{ₚ₊₁}_{^{y}}^{A}^{ᵢ}^{^{y}}(T−tₕ) represents a reliability function for the state transition process of the component Aᵢ^{y} from the state Bₚ₊₁^{y} to the state Bₚ₊₂^{y}; R_{B}_{ₚ}_{^{y}}^{A}^{ᵢ}^{^{y}}(tₕ₋₁−tₚ) represents the reliability function for the state transition process of the component Aᵢ^{y} from the state Bₚ^{y}to the state Bₚ₊₁^{y}; (T−tₕ) represents a time difference between the system operation time and the time when the h^{th} state transition process of the system happens; (tₕ₋₁−tₚ) represents a time difference between the time when the last state transition process of the system happens and the time when the p^{th} state transition process of the system happens; if the state Bₚ^{y} is the last state of the component Aᵢ^{y}, R_{B}_{ₚ₊₁}_{^{y}}^{A}^{ᵢ}^{^{y}}=1.

The calculation of the occurrence probabilities of the edges tₕ{Aᵢ^{s}:Bₚ^{s}→Bₚ₊₁^{s}} and tₕ{Aᵢ^{o}:Bₚ^{o}→Bₚ₊₁^{o} } is similar that of the edge tₕ{Aᵢ^{y}:Bₚ^{y}→Bₚ₊₁^{y}}.

For the second case that the state transition process happens and the warm standby component is activated (namely the second kind of nodes) at the time tₕ, the state transition process can be represented as Aᵢ^{y}|Aᵢ^{o}→(Aⱼ_{₁}^{s}, . . . ,Aⱼ_{ᵣ}^{s}); that is to say, the component Aᵢ^{y} or the component Aᵢ^{o} is transited from the state Bₚ^{y}|Bₚ^{o} to Bₚ₊₁^{o}|Bₚ₊₁^{o}, and r components Aⱼ_{ₛ}^{s}, . . . ,Aⱼ_{ᵣ}, in the warm standby mode are transited from the state Bₚ^{s}, to the state Bₚ_{ᵣ}^{o}.

The edges can be divided into two types according to the corresponding state transition process, respectively tₕ{Aᵢ^{y}:Bₚ^{y}→Bₚ₊₁^{y},Aⱼ_{ᵣ}^{s}:Bₚ_{ᵣ}^{s}→Bₚ_{ᵣ}^{o}} and tₕ{Aᵢ^{o}:Bₚ^{o}→Bₚ₊₁^{o},Aⱼ_{ᵣ}^{s}:Bₚ_{ᵣ}^{s}→Bₚ_{ᵣ}^{o}}. The edge tₕ{Aᵢ^{y}:Bₚ^{y}→Bₚ₊₁^{y},Aⱼ_{ᵣ}^{s}:Bₚ_{ᵣ}^{s}→Bₚ_{ᵣ}^{o}} is taken as an example, and the occurrence probability Prₑ^{g} (T) thereof is calculated through formulas of:

$$\{ \begin{matrix}\frac{{\int }_{{t}_{h - 1}}^{T} {\prod }_{n = 1}^{r} {R}_{{B}_{{p}_{u}}}^{{A}_{{i}_{u}}^{s}} ( {t}_{h} - {t}_{{p}_{u}} ) {R}_{{B}_{{p}_{u}}}^{{A}_{{j}_{u}}^{o}} ( T - {t}_{h} ) {R}_{{B}_{p}^{y}}^{{A}_{i}^{y}} ( {t}_{h - 1} - {t}_{p} ) {dF}_{{B}_{p}^{y}}^{{A}_{i}^{y}} ( {t}_{h} - {t}_{p} ) {R}_{{B}_{p + 1}^{y}}^{{A}_{i}^{y}} ( T - {t}_{h} )}{{\prod }_{i = 1}^{r} {R}_{{B}_{u}}^{{A}_{{j}_{u}}^{s}} ( T - {t}_{{p}_{u}} ) {R}_{{B}_{p}^{y}}^{{A}_{i}^{y}} ( T - {t}_{p} )} , {t}_{h - 1} > {t}_{p} \\ \frac{{\int }_{{τ}_{i - 1}}^{T} {\prod }_{i = 1}^{r} {R}_{{B}_{{p}_{u}}}^{{A}_{{j}_{u}}^{s}} ( {t}_{h} - {t}_{{p}_{u}} ) {R}_{{B}_{{p}_{u}}}^{{A}_{{i}_{u}}^{o}} ( T - {t}_{h} ) {dF}_{{B}_{p}^{y}}^{{A}_{i}^{y}} ( {t}_{h} - {t}_{p} ) {R}_{{B}_{p + 1}^{y}}^{{A}_{i}^{y}} ( T - {t}_{h} )}{{\prod }_{i = 1}^{r} {R}_{{B}_{{p}_{u}}}^{{A}_{{j}_{u}}^{s}} ( T - {t}_{{p}_{u}} ) {R}_{{B}_{p}^{y}}^{{A}_{i}^{y}} ( T - {t}_{p} )} , {t}_{h - 1} = {t}_{p} \end{matrix} ;$$

wherein: r represents the number of the components which are activated from the warm standby mode into the operating mode by the state transition process; tₚ_{ᵤ} represents the initial time of the u^{th} activated component in the warm standby mode in the state Bₚ_{ᵤ}; if the state Bₚ₊₁^{y} is the last state of the component Aᵢ^{y}, R_{B}_{ₚᵤ}^{A}^{ⱼᵤ}^{^{o}} =1.

The calculation of the occurrence probability of the edge tₕ{Aᵢ^{o}:Bₚ^{o}→Bₚ₊₁^{o},Aⱼ_{ᵣ}^{s}:Bₚ_{ᵣ}^{s}→Bₚ_{ᵣ}^{o}} is similar to that of the edge tₕ{Aᵢ^{y}:Bₚ^{y}→Bₚ₊₁^{y},Aⱼ_{ᵣ}^{s}:Bₚ_{ᵣ}^{s}→Bₚ_{ᵣ}^{o}}.

In the step (3), the occurrence probability P₀(T) of the root node is:

$${P}_{0} ( T ) = {\sum }_{i = 1}^{k} {R}_{{B}_{1}}^{{A}_{i}^{y}} ( T ) \cdot {\sum }_{i = k + 1}^{N} {R}_{{B}_{i}}^{{A}_{i}^{s}} ( T ) ;$$

wherein: k is the total number of the components in the operating mode at the initial time of the system; R_{B}_{₁}^{A}^{ᵢ}^{^{y}}(T) represents a reliability function for the state transition process of the component Aᵢ^{y} from the state B₁^{y} to the state B₂^{y}; R_{B}_{₁}^{A}^{ᵢ}^{^{s}}(T) represents a reliability function for the state transition process of the component Aᵢ^{s} from the state B₁^{s} to the state B₂^{s}.

In the step (3), the occurrence probability Pₑ of the e^{th} path is calculated through a formula of:

$${P}_{e} ( T ) = {P}_{0} ( T ) \cdot {Π}_{g} {Pr}_{e}^{g} ( T ) ;$$

wherein: Prₑ^{g} is the occurrence probability of the g^{th} path included in the e^{th} path, e=1, . . . ,E; e represents the path sequence number in the multi-state decision diagram; E represents the total number of the paths in the multi-state decision diagram; and P₀(T) represents the occurrence probability of the root node.

In the step (4), the failure probability qₑ^{l} of activating the l^{th} warm standby component in the e^{th} path is considered; after considering the failure probability of the component activation with the following formula, the occurrence probability P′ₑ of the e^{th} path is that:

$${P}_{e}^{′} ( T ) = {\prod }_{l = 1}^{L} ( 1 - {q}_{e}^{l} ) \cdot {P}_{e} ( T ) = {\prod }_{l = 1}^{L} ( 1 - {q}_{e}^{l} ) \cdot {P}_{0} ( T ) \cdot {Π}_{g} {Pr}_{e}^{g} ( T ) ;$$

wherein: L is the number of the components activated from the warm standby mode to the operating mode in the e^{th} path; qₑ^{l} is the failure probability of activating the l^{th} warm standby component in the e^{th} path.

In the step (5), the system reliability is obtained through adding up the occurrence probability of each path in the system with a formula of:

$${P}_{system} = {\sum }_{e = 1}^{E} {P}_{e}^{′} ;$$

wherein: P′ₑ is the occurrence probability of the e^{th} path after considering the failure probability of the component activation.

In order to programmatically implement the proposed method in the present invention, after establishing the multi-state decision diagram, the multi-state decision diagram is decomposed. The paths in the diagram which have the same number of state transition processes form the sub-diagrams (wherein each layer serves as one sub-diagram). For each sub-diagram, the occurrence probability of the sub-diagram is the summation of the occurrence probabilities of the paths in the sub-diagram. The system reliability can be obtained by adding up all occurrence probabilities of the sub-diagrams and the root node.

The present invention has following beneficial effects.

The present invention takes the warm standby system with the multi-state components as the object, and is able to programmatically process the multi-state components whose state transitions follow the arbitrary distributions with high accuracy and fast computing speed.

The method provided by the present invention further improves the reliability analysis theory of the multi-state system, which is of great significance to the reliability analysis theory and engineering applications of the multi-state system whose state transitions follow the arbitrary distributions, and provides an effective technology approach.

Compared with the existing analysis and calculation methods for system reliability, the present invention has advantages for a wider scope of application for warm standby systems composed of multi-state components with arbitrary state transition distributions. The programmed automatic analysis can be executed for the system reliability analysis and not limited to the integral formulas requiring the manual operation of the path occurrence probabilities. In the practical engineering applications and reliability analysis, the present invention has the better effect.

### BRIEF DESCRIPTION OF THE DRAWINGS

FIG. 1 presents two cases of component state transition, wherein FIG. 1A indicates discontinuous state transition and FIG. 113 indicates continuous state transition.

FIG. 2 is a sketch view of a multi-state decision diagram of a warm standby system according to a preferred embodiment of the present invention.

FIG. 3 shows decomposition of the multi-state decision diagram according to the preferred embodiment of the present invention, wherein FIG. 3A indicates once state transition of the system and FIG. 3B indicates twice state transition of the system.

FIG. 4 shows a curve diagram of time-varying system ability calculated with two methods according to the preferred embodiment of the present invention.

FIG. 5 is a curve diagram of the system reliability with considering different start failure probabilities according to the preferred embodiment of the present invention.

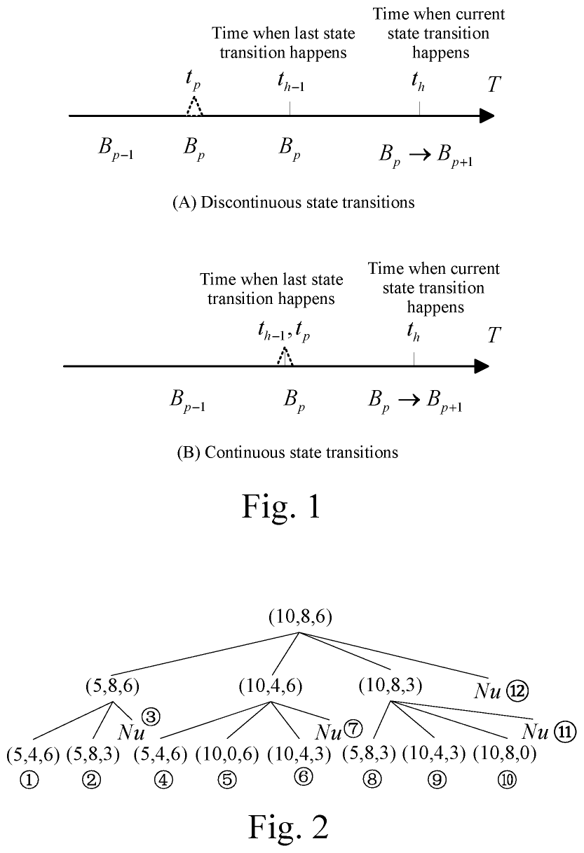

### DETAILED DESCRIPTION OF THE PREFERRED EMBODIMENT

The present invention is further described with the preferred embodiment and accompanying drawings as follows.

According to the preferred embodiment of the present invention, three components (A₁, a₂ and A₃) exist in a warm standby system, states and capacities of the components are showed in Table 1, and a capacity demand of the system is 15. Time distributions of state transitions of the components follow Weibull distributions, and parameters thereof are showed in Table 2. It can be known from the component capacities and the capacity demand of the system that: at an initial time of system operation, the components A₁ and A₂ are in an operating mode, and the component A₃ is in a warm standby mode. Start failure probabilities q of the warm standby component A₃ are respectively 0, 0.1 and 0.2.

TABLE 1
States and capacities of components in system

| Component/state/capacity | 1 | 2 | 3 |
|---|---|---|---|
| A₁ | 10 | 5 | 0 |
| A₂ | 8 | 4 | 0 |
| A₃ | 6 | 3 | 0 |

TABLE 2
Parameters of Weibull distributions
for state transitions of components

| | | State 1 → State 2 | | State 2 → State 3 | |
|---|---|---|---|---|---|
| | | Scale | Shape | Scale | Shape |
| Component/parameter | | parameter | parameter | parameter | parameter |
| A₁ | | 2 | 200 | 2 | 200 |
| A₂ | | 2 | 200 | 2 | 200 |
| A₃ | Warm | 1.5 | 300 | 1.5 | 300 |
| | standby | | | | |
| | mode | | | | |
| | Operating | 1.5 | 150 | 1.5 | 150 |
| | mode | | | | |

Calculation steps of a reliability analysis for the system are described as follows.

Through above steps, a multi-state decision diagram of the system is obtained, as shown in FIG. 2. If a third state transition process happens, the capacity demand of the system cannot be satisfied. Therefore, after two state transition processes, construction of the multi-state decision diagram is terminated. In FIG. 2, there are totally 12 paths in the multi-state decision diagram, which are numbered in sequence from left to right, wherein Nu represents that no component has state transition.

Based on the multi-state decision diagram, with utilizing numerical integration, an occurrence probability of each edge can be calculated.

An occurrence probability Pₒ(T) of a root node is that:

P₀(T)=R_{B}_{₁}^{A}^{₁}(T)·R_{B}_{₁}^{A}^{₂}(T)·R_{B}_{₁}^{A}^{₃}^{³}(T).

For the first path, the occurrence probability Pr₁¹(T) of the first edge t₁{A₁:B₁→B₂,A₃^{s}:B₁^{s}→B₁^{o}} is:

$${Pr}_{1}^{1} ( T ) = \frac{{\int }_{0}^{T} {R}_{{B}_{1}}^{{A}_{3}^{s}} ( {t}_{1} ) {R}_{{B}_{1}}^{{A}_{3}^{o}} ( T - {t}_{1} ) {dF}_{{B}_{1}}^{{A}_{1}} ( {t}_{1} ) {R}_{{B}_{2}}^{{A}_{1}} ( T - {t}_{1} )}{{R}_{{B}_{1}}^{{A}_{3}^{s}} ( T ) {R}_{{B}_{1}}^{{A}_{1}} ( T )} .$$

The occurrence probability Pr₁² (T) of the second edge t₂{A₂:B₁→B₂} is:

$${Pr}_{1}^{2} ( T ) = \frac{{\int }_{{t}_{1}}^{T} {dF}_{{B}_{1}}^{{A}_{2}} ( {t}_{2} ) {R}_{{B}_{2}}^{{A}_{2}} ( T - {t}_{2} )}{{R}_{{B}_{1}}^{{A}_{2}} ( T )} .$$

Thus, the occurrence probability P₁(T) of the first path in the multi-state decision diagram is:

P₁(T)=P₀(T)·Pr₁¹(T)·Pr₁²(T).

Considering the start failure probability q₁¹ of the warm standby component A₃, the occurrence probability of the first path is modified into:

P′₁(T)=P₁(T)·(1−q₁¹)=P₀(T)·Pr₁¹(T)·Pr₁²(T)·(1−q₁¹).

For the tenth path, the occurrence probability Pr₁₀¹(T) of the first edge t₁{A₃^{s}:B₁^{s}→B₂^{s}} is that:

$${Pr}_{10}^{1} ( T ) = \frac{{\int }_{0}^{T} {dF}_{{B}_{1}}^{{A}_{3}^{s}} ( {t}_{1} ) {R}_{{B}_{2}}^{{A}_{3}^{s}} ( T - {t}_{1} )}{{R}_{{B}_{1}}^{{A}_{3}^{s}} ( T )} .$$

The occurrence probability Pr₁₀²(T) of the second edge t₂{A₃^{s}:B₂^{s}→B₃^{s}} is that:

$${Pr}_{10}^{2} ( T ) = \frac{{\int }_{{t}_{1}}^{T} {dF}_{{B}_{2}}^{{A}_{3}^{s}} ( {t}_{2} - {t}_{1} )}{{R}_{{B}_{2}}^{{A}_{3}^{s}} ( T - {t}_{1} )} .$$

Thus, the occurrence probability P₁₀(T) of the tenth path in the multi-state decision diagram is:

P₁₀(T)=P₀(T)·Pr₁₀¹(T)·Pr₁₀²(T).

Because there is no standby component activated, the occurrence probability of the tenth path is modified into:

P′₁₀(T)=P₁₀(T)=P₀(T)·Pr₁₀¹(T)·Pr₁₀²(T).

It can be seen from FIG. 2 that the occurrence probability of the twelfth path is equal to that of the root node, namely:

P′₁₂(T)=P₁₂(T)=P₀(T).

The occurrence probabilities of other paths can be obtained similarly. The system reliability P_{system} is obtained that:

$${P}_{system} = {\sum }_{e = 1}^{12} {P}_{e}^{′} .$$

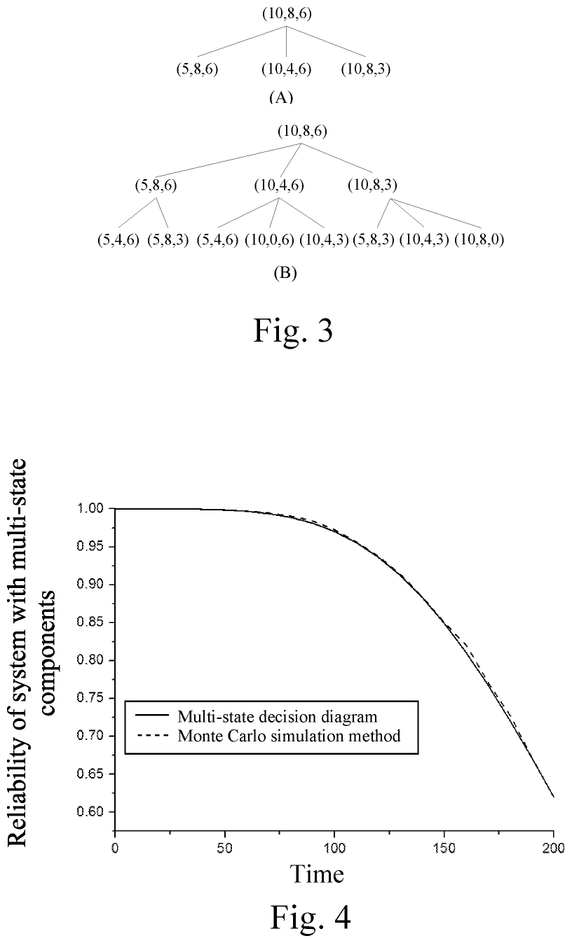

In order to achieve the programmatic implementation of the proposed method, according to the preferred embodiment, the multi-state decision diagram in FIG. 2 is decomposed as two sub-diagrams as presented in FIG. 3, which respectively correspond to once state transition (as shown in FIG. 3A) and twice state transition (as shown in FIG. 3B). Utilizing the numerical integration, the occurrence probability of the sub-diagrams can be obtained, and then the occurrence probabilities of the sub-diagrams and the root node are added up, so as to obtain the system reliability. The curve diagram of the time-varying reliability of the system is presented in FIG. 4. In order to validate the effectiveness of the proposed method, calculation results with utilizing the multi-state decision diagram and the results with the Monte Carlo simulation method are compared. In FIG. 4, as the system operation time increases, the reliability of the system decreases. Therefore, the correctness of the calculation results of the proposed method can be seen.

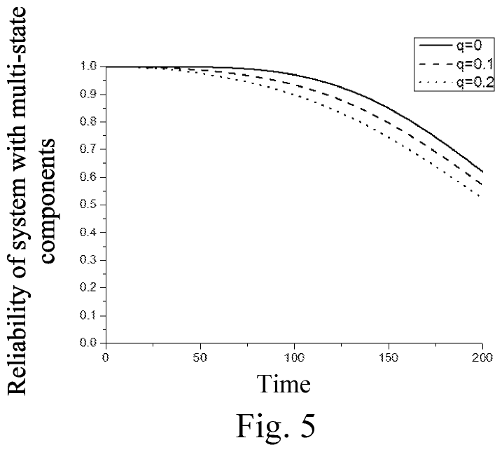

Moreover, the computation time of the proposed method is 67.31 s, while that of the Monte Carlo simulation method with 100,000 times of sampling is 326.16 s, which fully demonstrates the effectiveness of the proposed method and its superiority in the computation time. Considering the start failure probability of the warm standby components when activated, FIG. 5 presents the system reliability with different start failure probabilities. It shows that the start failure probability has certain influences on the system reliability. The start failure probability is greater, the system reliability is lower.

It should be noted that the above preferred embodiment is merely for illustrating the present invention, not for limiting the present invention. The present invention is described with the above preferred embodiment, and one skilled in the art can make modifications and equivalent replacements to the preferred embodiment. It should be known that all modifications and equivalent replacements made without departing from the spirit and scope of the present invention are all encompassed in the protection scope of the following claims.

1-15 (canceled)

16. An automatic reliability analysis method for a warm standby system based on a multi-state decision diagram, comprising steps of:
(1), constructing a multi-state model for the system with multi-state components;
(2), according to possible state transitions of every component in the system, constructing the multi-state decision diagram;
(3), calculating an occurrence probability Pₑ of an e^{th} path in the multi-state decision diagram;
(4), with considering start failure probabilities of the components, modifying the occurrence probability of the e^{th} path in the multi-state decision diagram into P′ₑ; and
(5), calculating a system reliability P_{system});
wherein: in the step (3), the occurrence probability Pₑ of the e^{th} path in the multi-state decision diagram is obtained through multiplying product of occurrence probabilities Prₑ^{g} of edges which the e^{th} path has passed through by an occurrence probability of a root node;
in the step (3), the component Aᵢ has three types according to whether an initial working mode and a subsequent working mode thereof are changed; the first type is the component Aᵢ^{y} which is in an operating mode at an initial time; the second type is the component which is always in a warm standby mode from the initial time; and the third type is the component Aᵢ^{o} which is in the warm standby mode at the initial time and then activated into the operating mode;
then the occurrence probabilities Prₑ^{g} of the edges are calculated as follows;
for a first case that a state transition process happens but no warm standby component is activated at a time tₕ, the state transition process is represented as Aᵢ^{y}|Aᵢ^{s}|Aᵢ^{o}→NA, wherein: Aᵢ^{y}→NA represents that a state of the component Aᵢ^{y} which is in the operating mode at the initial time of the system is transited from B_{P}^{y} to Bₚ₊₁^{y}; Aᵢ^{s}→NA represents that the stale of the component Aᵢ^{o} which is always in the warm standby mode from the initial time of the system is transited from Bₚ^{s} to Bₚ₊₁^{s}; Aᵢ^{o}→NA represents that the state of the component Aᵢ^{o} which is in the warm standby mode at the initial time of the system and then activated into the operating mode after the state transition process is transited from Bₚ^{o} to Bₚ₊₁^{o};
the edges are divided into three types according o the corresponding state transition process, respectively tₕ{Aᵢ^{y}:Bₚ^{y}→Bₚ₊₁^{y}}, tₕ{Aᵢ^{s}:Bₚ^{s}→Bₚ₊₁^{s}}, and tₕ{Aᵢ^{o}:Bₚ^{o}→Bₚ₊₁^{o} }; the occurrence probability Prₑ^{g} of the edge tₕ{Aᵢ^{y}:Bₚ^{y}→Bₚ₊₁^{y}} is calculated through formulas of:
$$\{ \begin{matrix}\frac{{\int }_{{t}_{h - 1}}^{T} {R}_{{B}_{p}^{y}}^{{A}_{i}^{y}} ( {t}_{h - 1} - {t}_{p} ) {dF}_{{B}_{p}^{y}}^{{A}_{i}^{y}} ( {t}_{h} - {t}_{p} ) {R}_{{B}_{p + 1}^{y}}^{{A}_{i}^{y}} ( T - {t}_{h} )}{{R}_{{B}_{p}^{y}}^{{A}_{i}^{y}} ( T - {t}_{h} )} , {t}_{h - 1} > {t}_{p} \\ \frac{{\int }_{{t}_{h - 1}}^{T} {dF}_{{B}_{p}^{y}}^{{A}_{i}^{y}} ( {t}_{h} - {t}_{p} ) {R}_{{B}_{p + 1}^{y}}^{{A}_{i}^{y}} ( T - {t}_{h} )}{{R}_{{B}_{p}^{y}}^{{A}_{i}^{y}} ( T - {t}_{h} )} , {t}_{h - 1} = {t}_{p} \end{matrix} ;$$
wherein: T represents an operation time of the system; tₕ₋₁ (0<tᵢ< . . . <tₕ₋₁<tₕ<T) represents a time when a last state transition process of the system happens; tₚ represents a starting time of the component Aᵢ^{y} in the state Bₚ^{y}; F_{B}_{ₚ}_{^{y}}^{A}^{ᵢ}^{^{y}}(tₕ−tₚ) is a cumulative distribution function for the state transition process of the component Aᵢ^{y} from the state Bₚ^{y} to the state Bₚ₊₁^{y}; (tₕ−tₚ) represents a time difference between a time when a h^{th} state transition process of the system happens and the starting time of the component in a p^{th} state; R_{B}_{ₚ}_{^{y}}^{A}^{ᵢ}^{^{y}}(T−tₕ) represents a reliability function for the state transition process of the component Aᵢ^{y} from the state the state Bₚ^{y} to the state Bₚ₊₁^{y}; R_{B}_{ₚ₊₁}_{^{y}}^{A}^{ᵢ}^{^{y}}(T−tₕ) represents a reliability function for the state transition process of the component Aᵢ^{y} from the state Bₚ₊₁^{y} to the state Bₚ₊₂^{y}; R_{B}_{ₚ}_{^{y}}^{A}^{ᵢ}^{^{y}}(t−tₕ) represents the reliability function for the state transition process of the component Aᵢ^{y} from the state Bₚ^{y} to the state Bₚ₊₁^{y}; (T−Tₕ) represents a time difference between the system operation time and the time when the h^{th} state transition process of the system happens; (tₕ₋₁−tₚ) represents a time difference between the time when the last state transition process of the system happens and the starting time of the component in the p^{th} state;
calculation of the occurrence probabilities of the edges tₕ{Aᵢ^{s}:Bₚ^{s}→Bₚ₊₁^{s}} and tₕ{Aᵢ^{o}:Bₚ^{o}→Bₚ₊₁^{o} } is similar that of the edge tₕ{Aᵢ^{y}:Bₚ^{y}→Bₚ₊₁^{y}}.
for a second case that the state transition process happens and the warm standby component is activated at the time tₕ, the state transition process is represented as Aᵢ^{y}|Aᵢ^{o}→(Aⱼ_{₁}^{s}, . . . ,Aⱼ_{ᵣ}^{s}); that is to say, the component Aᵢ^{y} or the component Aᵢ^{o} is transited from the state Bₚ^{y}|Bₚ^{o} to Bₚ₊₁^{y}|Bₚ₊₁^{o}, and r components Aⱼ_{ₛ}^{s}, . . . , Aⱼ_{ᵣ}in the warm standby mode are transited from the state Bₚ^{s}, to the state Bₚ^{o};
the edges are divided into two types according to the corresponding state transition process, respectively tₕ{Aᵢ^{y}:Bₚ^{y}→Bₚ₊₁^{y},Aⱼ_{ᵣ}^{s}:Bₚ_{ᵣ}^{s}→Bₚ_{ᵣ}^{o}} and tₕ{Aᵢ^{o}:Bₚ^{o}→Bₚ₊₁^{o},Aⱼ_{ᵣ}^{s}:Bₚ_{ᵣ}^{s}→Bₚ_{ᵣ}^{o}}; and the occurrence probability Pr₃^{g}(T) of the edge tₕ{Aᵢ^{y}:Bₚ^{y}→Bₚ₊₁^{y},Aⱼ_{ᵣ}^{s}:Bₚ_{ᵣ}^{s}→Bₚ_{ᵣ}^{o}} is calculated through formulas of:
$$\{ \begin{matrix}\frac{{\int }_{{t}_{h - 1}}^{T} {\prod }_{n = 1}^{r} {R}_{{B}_{{p}_{u}}}^{{A}_{{i}_{u}}^{s}} ( {t}_{h} - {t}_{{p}_{u}} ) {R}_{{B}_{{p}_{u}}}^{{A}_{{j}_{u}}^{o}} ( T - {t}_{h} ) {R}_{{B}_{p}^{y}}^{{A}_{i}^{y}} ( {t}_{h - 1} - {t}_{p} ) {dF}_{{B}_{p}^{y}}^{{A}_{i}^{y}} ( {t}_{h} - {t}_{p} ) {R}_{{B}_{p + 1}^{y}}^{{A}_{i}^{y}} ( T - {t}_{h} )}{{\prod }_{i = 1}^{r} {R}_{{B}_{u}}^{{A}_{{j}_{u}}^{s}} ( T - {t}_{{p}_{u}} ) {R}_{{B}_{p}^{y}}^{{A}_{i}^{y}} ( T - {t}_{p} )} , {t}_{h - 1} > {t}_{p} \\ \frac{{\int }_{{τ}_{i - 1}}^{T} {\prod }_{i = 1}^{r} {R}_{{B}_{{p}_{u}}}^{{A}_{{j}_{u}}^{s}} ( {t}_{h} - {t}_{{p}_{u}} ) {R}_{{B}_{{p}_{u}}}^{{A}_{{i}_{u}}^{o}} ( T - {t}_{h} ) {dF}_{{B}_{p}^{y}}^{{A}_{i}^{y}} ( {t}_{h} - {t}_{p} ) {R}_{{B}_{p + 1}^{y}}^{{A}_{i}^{y}} ( T - {t}_{h} )}{{\prod }_{i = 1}^{r} {R}_{{B}_{{p}_{u}}}^{{A}_{{j}_{u}}^{s}} ( T - {t}_{{p}_{u}} ) {R}_{{B}_{p}^{y}}^{{A}_{i}^{y}} ( T - {t}_{p} )} , {t}_{h - 1} = {t}_{p} \end{matrix} ;$$
wherein: r represents an amount of the components which are activated from the warm standby mode into the operating mode by the state transition process; tₚ_{ᵤ}, represents an initial time of a u^{th} activated component in the warm standby mode in the state B_{P}_{ᵤ}; and
calculation of the occurrence probability of the edge tₕ{Aᵢ^{o}:Bₚ^{o}→Bₚ₊₁^{o},Aⱼ_{ᵣ}^{s}:Bₚ_{ᵣ}^{s}→Bₚ_{ᵣ}^{o}} is similar to that of the edge tₕ{Aᵢ^{y}:Bₚ^{y}→Bₚ₊₁^{y},Aⱼ_{ᵣ}^{s}:Bₚ_{ᵣ}^{s}→Bₚ_{ᵣ}^{o}}.
